(19) United States
(12) Patent Application Publication
(10) Pub. No.: US 2017/0207446 A1
(43) Pub. Date: Jul. 20, 2017

(54) MATERIAL FOR ELECTRODE IN ENERGY STORAGE DEVICE USING METAL ORGANIC FRAMEWORKS WITH ELEMENT WITH UNSHARED ELECTRON PAIR, ENERGY STORAGE DEVICE COMPRISING THE SAME, AND METHOD FOR ANALYZING THE SAME

(71) Applicant: KOREA ADVANCED INSTITUTE OF SCIENCE AND TECHNOLOGY, Daejeon (KR)

(72) Inventors: Jeung Ku KANG, Daejeon (KR); Jung Hyo PARK, Daejeon (KR); Kyung Min CHOI, Daejeon (KR); Dong Ki LEE, Daejeon (KR); Byeong Cheul MOON, Daejeon (KR); Sang Rim SHIN, Daejeon (KR)

(73) Assignee: KOREA ADVANCED INSTITUTE OF SCIENCE AND TECHNOLOGY, Daejeon (KR)

(21) Appl. No.: 15/059,852

(22) Filed: Mar. 3, 2016

(30) Foreign Application Priority Data
Jan. 19, 2016 (KR) 10-2016-0006229

(51) Int. Cl. H01M 4/137; G01N 21/78; H01M 10/0525; G01N 21/33

(52) U.S. Cl. CPC H01M 4/137; G01N 21/33; G01N 21/78; H01M 10/0525; G01N 2201/061; H01M 2004/021

(57) ABSTRACT

Provided is an electrode material for an energy storage device, which comprises a metal organic framework, wherein an element having an unshared electron pair is doped to the organic linker of the metal organic framework. The electrode material for an energy storage device comprises a metal organic framework in which an element having an unshared electron pair is doped to the organic linker. The non-shared electron pair of the element doped to the electrode material is bound to high-order polysulfide to prevent the polysulfide from being transferred to lithium metal, thereby providing a good effect upon cycle characteristics and thus improving the cycle characteristics of an energy storage device, such as a lithium-sulfur battery. As a result, the metal organic framework having nitrogen doped thereto improves the cycle characteristics of an energy storage device, such as a lithium-sulfur battery, as a cathode thereof.

### CROSS-REFERENCE TO RELATED APPLICATIONS

This application claims priority under 35 U.S.C. §119 to Korean Patent Application No. 10-2016-0006229, filed on Jan. 19, 2016 in the Korean Intellectual Property Office, the disclosure of which is incorporated herein by reference in its entirety.

### TECHNICAL FIELD

The following disclosure relates to an electrode material for an energy storage device, an energy storage device including the same and a method for analyzing the same. More particularly, the following disclosure relates to an electrode material for an energy storage device having a doping element whose non-shared electron pair is bound to high-order polysulfide to prevent the polysulfide from being transferred to lithium metal, thereby providing a good effect upon cycle characteristics and thus improving the cycle characteristics of an energy storage device, such as a lithium-sulfur battery. The following disclosure also relates to an energy storage device including the same and a method for analyzing the same.

### BACKGROUND

A lithium-sulfur (Li—S) battery that is an energy storage device has a theoretical energy density of 2600 Wh/kg and a theoretical capacity of 1672 mAh/g. Thus, since such a lithium-sulfur battery shows an energy density three to five times higher than the energy density of a conventional lithium battery, it has been given many attentions as a next-generation energy storage device. However, it has too low cycle characteristics to be commercialized. Therefore, many studies have been conducted to improve the cycle characteristics through the use of various methods.

Particularly, there has been frequently used a method for preventing volumetric expansion of sulfur and increasing conductivity by using a carbonaceous material, such as graphene and active carbon, as a template. However, such a method still has many disadvantages, thereby making it difficult to commercialize a lithium-sulfur battery using the method. Accordingly, it is required that another method is suggested to accomplish the commercialization of a lithium-sulfur battery.

Under these circumstances, the inventors of the present disclosure have conducted intensive studies to improve cycle characteristics and capacity by using metal organic frameworks. Such metal organic frameworks were reported first by the professor Omar M. Yaghi (University of California, Berkeley). They are three-dimensional porous materials having an array in which metal blocks and organic linkers are repeated and obtained by a hydrothermal synthesis process including introducing a metal precursor and an organic linker to a specific solvent.

A metal organic framework has micropores and mesopores with different sizes. It also has a very large specific surface area, and thus has been utilized as a gas storage device. In addition, although a metal organic framework has a disadvantage of low conductivity and thus electrochemical use of a metal organic framework has not been allowed. However, more recently, a nano-sized metal organic framework has been prepared and used for electrochemical applications so that its applicability has been increased. In addition, metal organic frameworks have various combinations of metal precursors with organic linkers, and thus several thousands of crystal structures have been registered in a database. Further, since various functional groups may be incorporated to metal organic frameworks, metal organic frameworks have a large spectrum of applications. However, there is no suggestion or disclosure about the applicability of a metal organic framework as an electrode material for a lithium-sulfur battery.

### SUMMARY

An embodiment of the present disclosure is directed to providing an electrode material for an energy storage device using a metal organic framework and an energy storage device including the same.

In one aspect, there is provided an electrode material for an energy storage device that includes a metal organic framework having an organic linker to which an element having an unshared electron pair is doped. The unshared electrode pair of the element doped to the electrode material disclosed herein is bound to high-order polysulfide to prevent the polysulfide from being transferred to lithium metal, thereby providing a good effect upon cycle characteristics. As a result, the metal organic framework to which nitrogen is doped according to an embodiment improves the cycle characteristics of an energy storage device, such as a lithium-sulfur battery, as a cathode thereof.

### BRIEF DESCRIPTION OF THE DRAWINGS

FIG. 1A and FIG. 1B are schematic view illustrating that MOF-867 and UiO-67 have the same structure but nitrogen in the organic linker of MOF-867 can be bound chemically to polysulfide.

FIG. 2A shows the results obtained from analysis of crystallinity determined by Powder X-ray Diffractometry (PXRD).

FIG. 2B shows the results obtained from analysis of specific surface area of the organic linker according to an embodiment.

FIG. 2C and FIG. 2E show the results of analysis of crystal shapes.

FIG. 2D and FIG. 2F show the results of analysis of Energy Dispersive Spectrometry (EDS) mapping.

FIG. 3A, FIG. 3B, FIG. 3C, FIG. 3D and FIG. 3E show the results of analysis of cycle characteristics for the cathodes of Example and Comparative Example.

FIG. 4A and FIG. 4B show the results obtained from Fourier Transform Infrared Spectrometry (FT-IR).

FIG. 4C and FIG. 4D show the results obtained from X-ray Photoelectron Spectrometry (XPS).

FIG. 4E is an image taken after introducing nMOF-867 to Li₂S₄ solution.

FIG. 4F shows the results of analysis of a change in color as determined by UV-visible spectrometry.

FIG. 5A shows a schematic view of a UV-visible spectrometer for in-situ determination of a binding degree of the cathode according to an embodiment to polysulfide.

FIG. 5B and FIG. 5C show the results of the analysis of absorbance obtained through the spectrometer as shown in FIG. 5A.

### DETAILED DESCRIPTION OF EMBODIMENTS

The advantages, features and aspects of the present disclosure will become apparent from the following description of the embodiments with reference to the accompanying drawings, which is set forth hereinafter.

The present disclosure may, however, be embodied in different forms and should not be construed as limited to the embodiments set forth herein. In the drawings, some parts not related with the present disclosure are eliminated for clarity and like reference numerals denote like elements.

Throughout the disclosure, the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

As used herein, the terms “about”, “substantially” or the like combined with a number have the meaning of proximity to the corresponding number when a specific allowable error for preparation or materials is defined, and are used in order to prevent any unscrupulous invader from unduly using the disclosure about an accurate or absolute number provided to help understanding of the present disclosure. In addition, throughput the specification, “step of . . . ” or “step for . . . ” does not mean “step for the purpose of . . . ”.

Throughout the specification, the term “combination thereof” included in Markush type claims denotes at least one mixture or combination selected from the elements described in such Markush type claims and means the inclusion of at least one selected from the group consisting of such elements.

Throughout the specification, the expression “A and/or B” means “A or B, or A and B”.

As mentioned above, the electrode material for an energy storage device disclosed herein uses a metal organic framework. According to an embodiment, the energy storage device is a lithium-sulfur battery but is not limited thereto.

According to an embodiment, an element having an unshared electron pair is doped to the organic linker of the metal organic framework. The unshared electron pair of the doped element is bound to polysulfide of a lithium-sulfur battery. In this manner, it is possible to prevent polysulfide from being transferred from the micropores of the metal organic framework to the counter electrode, thereby improving cycle characteristics.

According to an embodiment, nitrogen is used as an element having an unshared electron pair. However, in addition to nitrogen, oxygen, sulfur or the like also have an unshared electron pair. Thus, the scope of the present disclosure covers any elements having an unshared electron pair and capable of being bound to polysulfide of a lithium-sulfur battery.

According to an embodiment, Example (MOF-867) to which nitrogen is doped and Comparative Example (UiO-67) to which nitrogen is not doped are compared with each other to demonstrate that the unshared electron pair of nitrogen is bound to high-order polysulfide so that polysulfide is prevented from being transferred to lithium metal, thereby improving cycle characteristics. In addition, in-situ UV-vis spectrometry is used to demonstrate that nitrogen is bound to polysulfide.

In other words, MOF-867 (Example) and UiO-67 (Comparative Example) have the completely same crystal structure. However, only the organic linker of MOF-867 has nitrogen doped thereto so that the effect of nitrogen may be determined while the other conditions are controlled.

As used herein, both MOF-867 (Example) and UiO-67 (Comparative Example) use zirconium as a metal precursor. However, MOF-867 uses 2,2′-bipyridine-5,5′-dicarboxylate (BPYDC) as its organic linker and UiO-67 is prepared through a hydrothermal process using 4,4′-biphenyldicarboxylate (BPDC). In addition, since transfer of lithium ions are affected significantly by the size of a crystal structure in a cycle reaction, Example and Comparative Example are prepared to have the same nano-size and then compared with each other in terms of cycle characteristics.

To provide the lithium-sulfur energy storage device using the above-described metal organic framework, several steps are carried out.

### EXAMPLE

First, MOF-867 having a nano-scaled size is prepared according to Example. In the case of MOF-867, zirconium chloride (9.2 mg) and acetic acid (1.38 mL) are dissolved into N,N-dimethylformamide (DMF, 5 mL) solution. Next, 2,2′-bipyridine-5,5′-dicarboxylic acid (9.25 mg) as an organic linker and trimethylamine (35 μL) are dissolved into 5 mL of DMF solution. Then, the two solutions are mixed in a 20 mL vial and dispersed for 10 minutes by using an ultrasonication dispersion system. After that, the vial is allowed to stand at 85° C. for 12 hours to carry out reaction. Thus, white precipitate is obtained. After the reaction, the reaction mixture is washed with DMF and methanol by using a centrifugal separator. The obtained product is dried at 100° C. for 24 hours in a vacuum oven so that it may be used for its final application.

### Comparative Example

In the case of UiO-67 as Comparative Example, the same metal precursor and solvent as MOF-867 are used, except that a different organic linker is used. UiO-67 is obtained in the following manner.

Zirconium chloride (18.64 mg) and acetic acid (1.38 mL) are dissolved into N,N-dimethylformamide (DMF, 5 mL) solution. Next, 4,4′-biphenyldicarboxylate (19.36 mg) as an organic linker and trimethylamine (35 μL) are dissolved into 5 mL of DMF solution. Then, the two solutions are mixed in a 20 mL vial and dispersed for 10 minutes by using an ultrasonication dispersion system. After that, the vial is allowed to stand at 85° C. for 6 hours to carry out reaction. Thus, white precipitate is obtained. After the reaction, the reaction mixture is washed with DMF and methanol by using a centrifugal separator. The obtained product is dried at 100° C. for 24 hours in a vacuum oven so that it may be used for its final application.

### Test Example 1

Each of the nano-sized MOF-867 and UiO-67 obtained through the above-described hydrothermal process is mixed with sulfur and dispersed homogeneously in a mortar. Next, the resultant mixture is introduced to a sealable chamber and heated therein at a rate of 1° C./minute to carry out heat treatment at 155° C. for 12 hours so that sulfur may be incorporated into the micropores. The obtained composite of MOF with sulfur is stored in a glove box to avoid its contact with moisture.

### Test Example 2

To form an artificial binding between nitrogen and polysulfide (Li₂S₄), sulfur and Li₂S are mixed at a stoichiometric ratio in tetraethylene glycol dimethyl ether (TEGDME) as a solvent to obtain Li₂S₄ solution. Then, the solution is mixed with MOF-867 dried as described above to form an artificial binding with nitrogen.

### Test Example 3

To carry out electrochemical determination, (PYR14TFSI)/1,2-dimethoxyethane/1,3-dioxolane are mixed to form a solution at a volume ratio of 2:1:1 and LiNO₃ is dissolved therein at a concentration of 1 wt %. Next, lithium bis(trifluoromethanesulfonyl)imide (LiTFSI) is dissolved at a concentration of 1M to form an electrolyte. A 2032 type coin cell is used and the active material is applied to aluminum foil through blading. Electrochemical determination is carried out within a voltage range of 1.7-2.8V at a current value of 167 mA/g and 835 mA/g.

Analysis

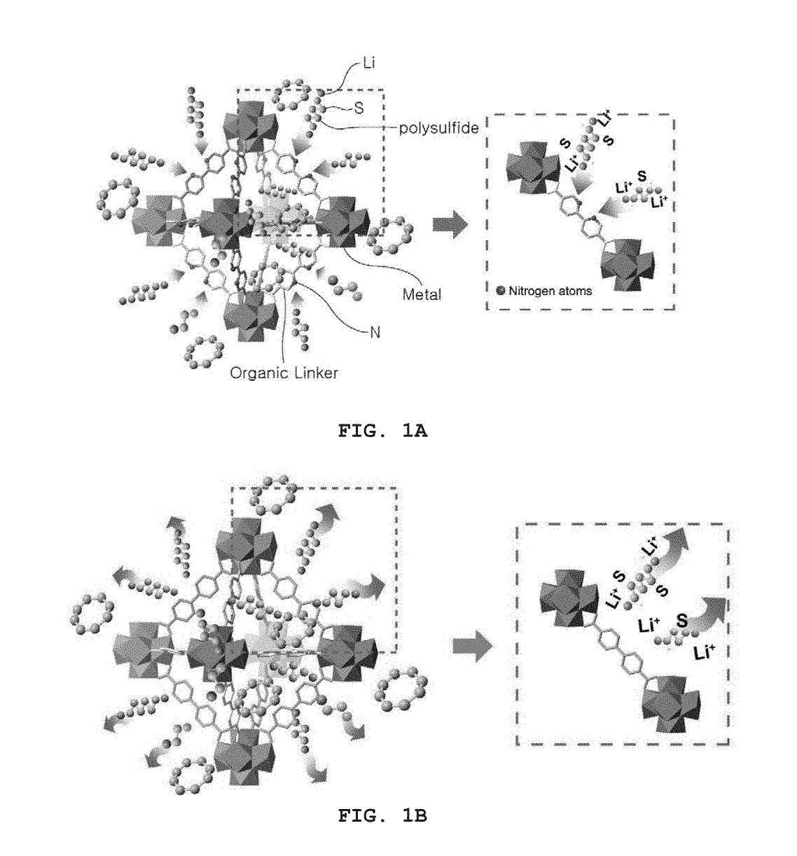

FIG. 1A and FIG. 1B are schematic views illustrating that MOF-867 and UiO-67 have the same structure but nitrogen in the organic linker of MOF-867 can be bound chemically to polysulfide.

Referring to FIG. 1A and FIG. 1B, the same metal, zirconium, is used for metal organic frameworks. In the organic linkers, there is a difference in nitrogen represented by the red dots. In other words, according to FIG. 1A, it can be seen that polysulfide remains in the micropores of a cathode due to the binding between nitrogen doped to the organic linker of MOF-867 and polysulfide. It can be seen from FIG. 1B that polysulfide generated during repeated cycles is released from the micropores. As a result, nitrogen in the organic linker of the metal organic framework used as a cathode according to an embodiment is bound to polysulfide to prevent polysulfide from being transferred to the counter electrode, thereby improving the cycle characteristics of a lithium-sulfur battery.

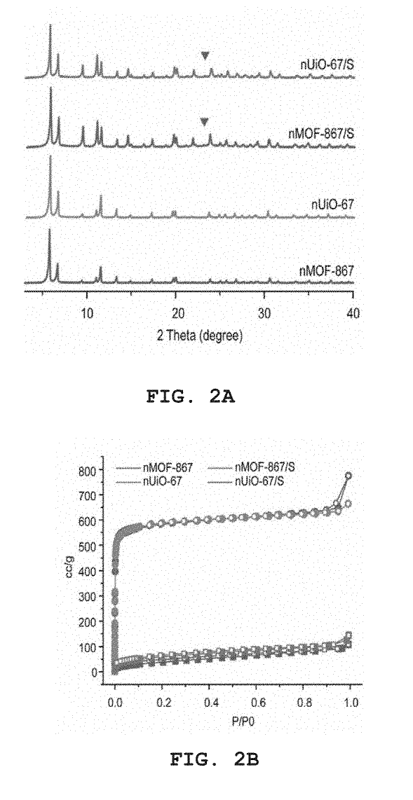

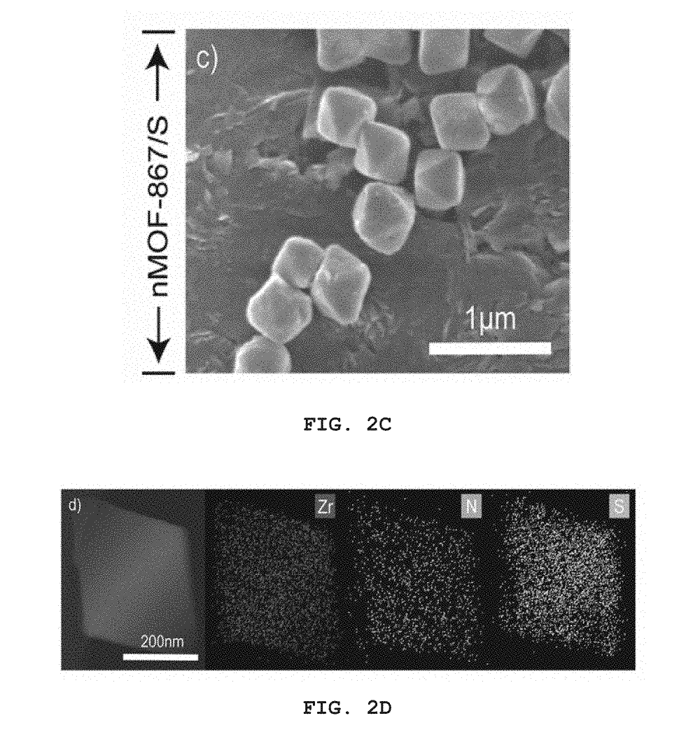

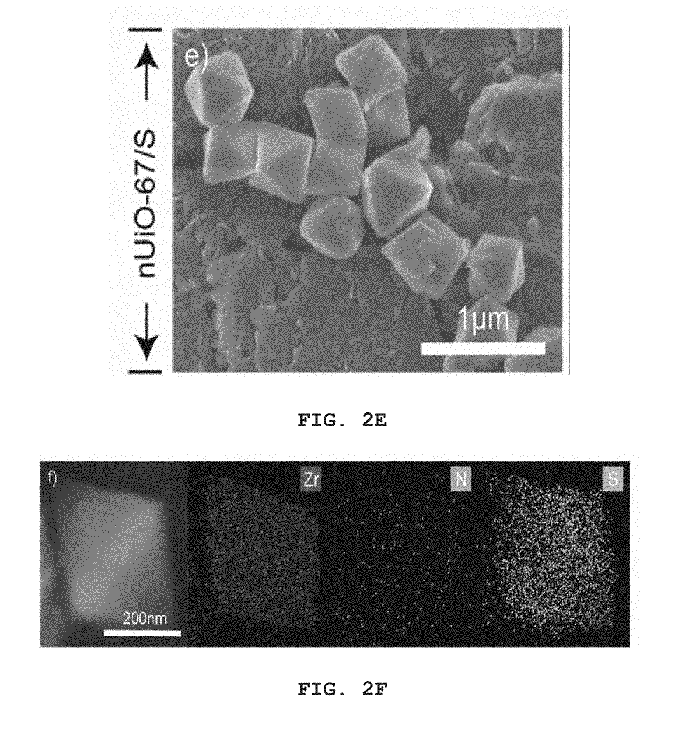

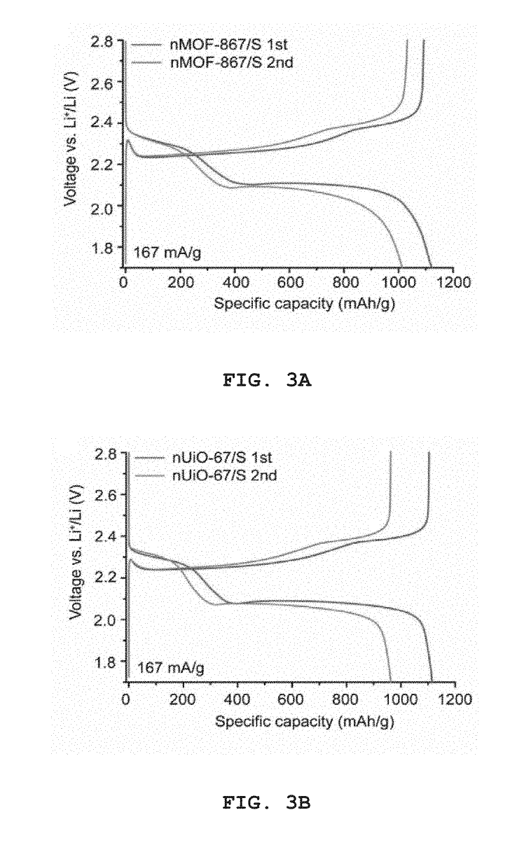

FIG. 2A shows the results obtained from analysis of crystallinity determined by Powder X-ray Diffractometry (PXRD). FIG. 2B shows the results obtained from analysis of specific surface area of the organic linker according to an embodiment. FIG. 2C and FIG. 2E show the results obtained from analysis of crystal shapes. FIG. 2D and FIG. 2E show the results obtained from analysis of Energy Dispersive Spectrometry (EDS) mapping.

Referring to FIG. 2A, it can be seen from PXRD analysis that both MOF-867 and UiO-67 have high crystallinity and the crystallinity of metal organic frameworks is maintained even after sulfur is heat treated and incorporated to the micropores. In addition, it can be seen from FIG. 2B that MOF-867 and UiO-67 have Type 1 and a specific surface area of about 2250 m²/g as determined by BET specific surface area measurement using nitrogen. Further, it can be seen that both MOF-867 and UiO-67 have a decreased specific surface area of about 140 m²/g after sulfur is heat treated and incorporated to the micropores.

Additionally, FIG. 2C and FIG. 2E demonstrate that both MOF-867 and UiO-67 retain their octahedral crystal structures even after sulfur is supported in the micropores.

It can be seen from FIG. 2D and FIG. 2F that Zr and S are detected through EDS mapping, N is detected only in the case of MOF-867, and the porous materials have a relatively uniform size of about 100 nm.

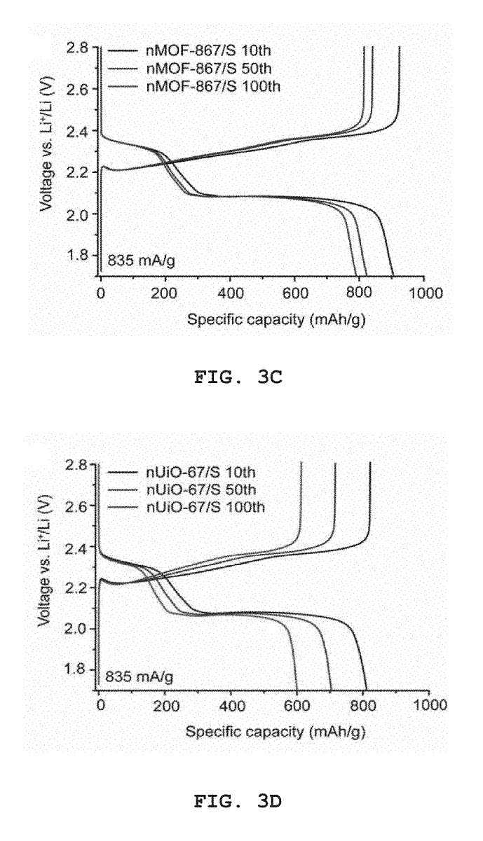

FIG. 3A, FIG. 3B, FIG. 3C, FIG. 3D and FIG. 3E show the results of analysis of cycle characteristics for the cathodes of Example and Comparative Example.

FIG. 3A shows the results of the first and second cycle characteristics of nMOF-867/S at 167 mA/g. FIG. 3B shows the results of the first and second cycle characteristics of nUiO-67/S at 167 mA/g. FIG. 3C shows the results of the 10^{th}, 50^{th}and 100^{th} cycle characteristics of nMOF-867/S at 835 mA/g. FIG. 3D shows the results of the 10^{th}, 50^{th} and 100^{th} cycle characteristics of nUiO-67/S at 835 mA/g. It can be seen from FIG. 3E that nMOF-867/S has higher cycle characteristics after comparing the 500^{th} cycle characteristics of nMOF-867/S and nUiO-67/S at 835 mA/g, which have a Coulomb efficiency of 98% and 96%, respectively.

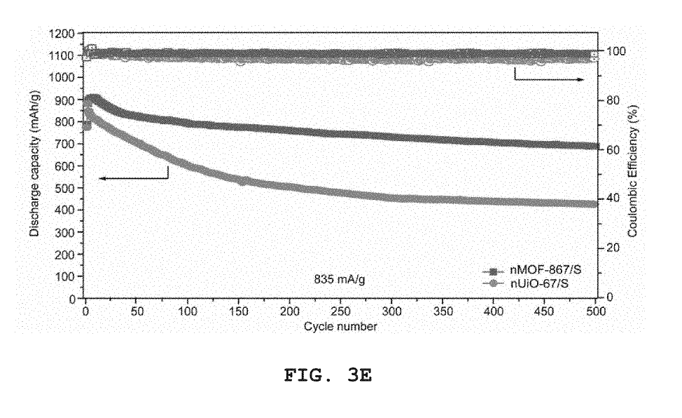

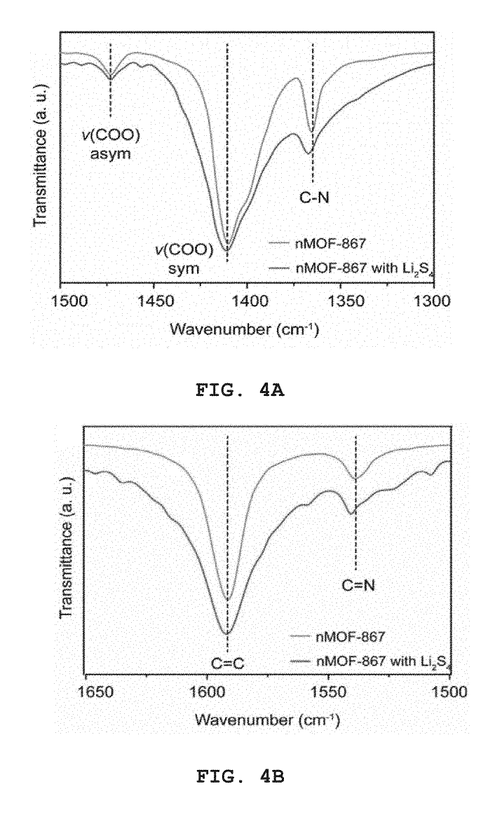

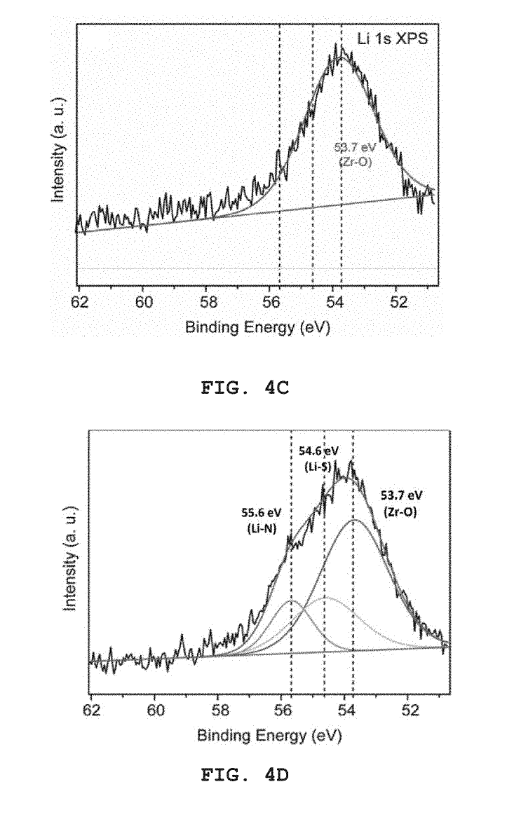

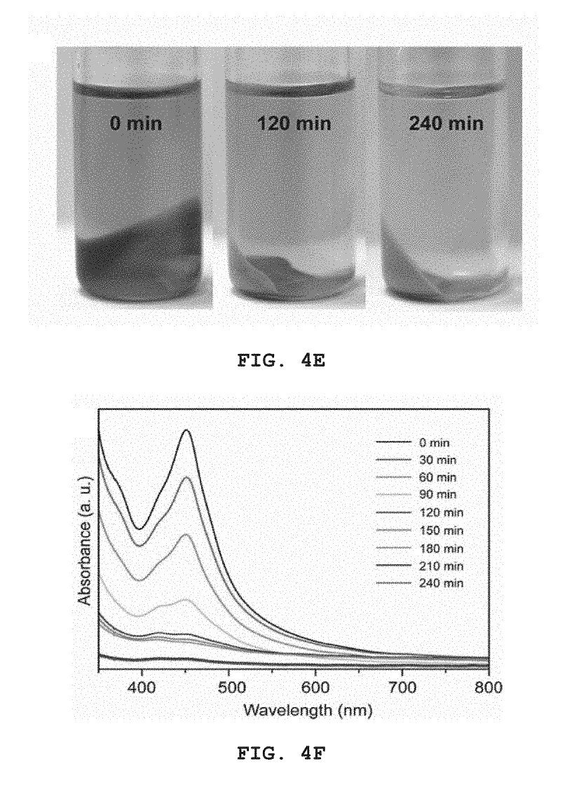

FIG. 4A and FIG. 4B show the results obtained from Fourier Transform Infrared Spectrometry (FT-IR). FIG. 4C and FIG. 4D show the results obtained from X-ray Photoelectron Spectrometry (XPS), FIG. 4E is an image taken after introducing nMOF-867 to Li₂S₄ solution. FIG. 4F shows the results of analysis of a change in color as determined by UV-visible spectrometry.

As can be seen from FIG. 4A and FIG. 4B, FT-IR analysis carried out after nMOF-867 is reacted artificially with Li₂S₄ to form a binding between nitrogen and Li₂S₄ shows that C═N and C—N bindings are transferred but the other bindings undergo no change.

In addition, it can be seen from FIG. 4C and FIG. 4D that XPS analysis demonstrates a chemical binding between nitrogen and Li₂S₄. In FIG. 4E, it is observed that the color of Li₂S₄ solution is gradually weakened after nMOF-867 is added to and mixed with Li₂S₄ solution, which suggests that nitrogen strongly attracts Li₂S₄. The results of UV-visible spectrometry as shown in FIG. 4F demonstrate a change in color more clearly.

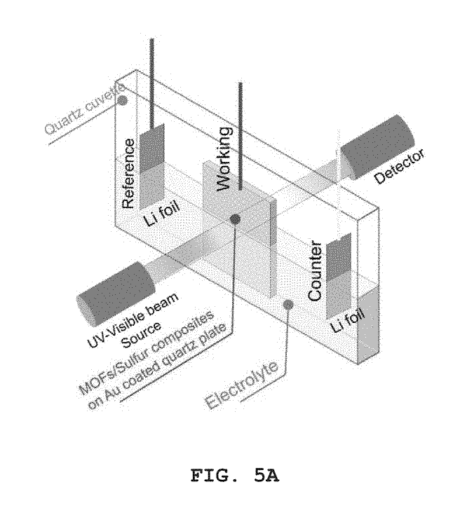

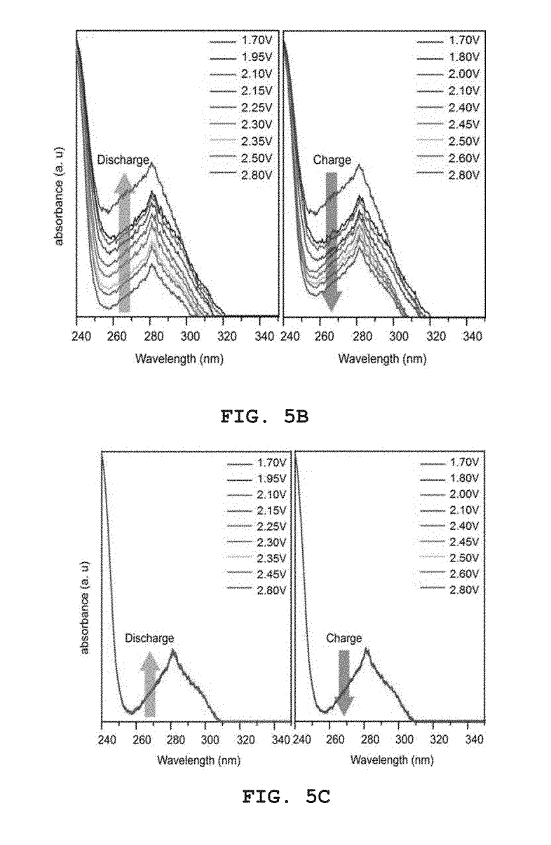

FIG. 5A shows a schematic view of a UV-visible spectrometer for in-situ determination of a binding degree of the cathode according to an embodiment with polysulfide. FIG. 5B and FIG. 5C show the analysis results of absorbance obtained through the spectrometer as shown in FIG. 5A.

In other words, there is provided a method for analyzing a cathode material for a lithium-sulfur (Li—S) battery, the method including the steps of: mixing a cathode material for a lithium-sulfur (Li—S) battery with solution to which polysulfide is added; irradiating the solution with light after the mixing to determine the absorbance; and determining whether the cathode material for a lithium-sulfur (Li—S) battery is bound to polysulfide or not according to a change in absorbance. Herein, the light is one generated from a UV-visible beam light source.

It can be seen from FIG. 5B that when nMOF-867S having an organic linker to which nitrogen is doped according to Example is subjected to cyclic voltammetry (CV) while determining the absorbance, the absorbance is increased and then reduced during CV. It can be seen from FIG. 5C that when nUiO-67/S having an organic linker to which nitrogen is not doped is subjected to CV while determining absorbance, the absorbance undergoes little change during CV.

While the present disclosure has been described with respect to the specific embodiments, it will be apparent to those skilled in the art that various changes and modifications may be made without departing from the spirit and scope of the disclosure as defined in the following claims.

What is claimed is:

1. An electrode material for an energy storage device, which comprises a metal organic framework, wherein an element having an unshared electron pair is doped to the organic linker of the metal organic framework.

2. The electrode material for an energy storage device according to claim 1, wherein the energy storage device is a lithium-sulfur (Li—S) battery.

3. The electrode material for an energy storage device according to claim 2, wherein the unshared electron pair of the element is bound to polysulfide of the lithium-sulfur battery.

4. The electrode material for an energy storage device according to claim 3, wherein the element is any one selected from the group consisting of nitrogen, phosphorus, oxygen, sulfur and a combination thereof.

5. The electrode material for an energy storage device according to claim 4, wherein the element is nitrogen.

6. The electrode material for an energy storage device according to claim 5, which has micropores and polysulfide is bound to nitrogen in the micropores.

7. An energy storage device comprising the electrode material for an energy storage device as defined in claim 1.

8. An energy storage device comprising the electrode material for an energy storage device as defined in claim 2.

9. An energy storage device comprising the electrode material for an energy storage device as defined in claim 3.

10. An energy storage device comprising the electrode material for an energy storage device as defined in claim 4.

11. An energy storage device comprising the electrode material for an energy storage device as defined in claim 5.

12. An energy storage device comprising the electrode material for an energy storage device as defined in claim 6.

13. The energy storage device according to claim 7, which is a lithium-sulfur (Li—S) battery.

14. The energy storage device according to claim 13, wherein the electrode material for an energy storage device forms a cathode of a lithium-sulfur (Li—S) battery.

15. A method for analyzing the electrode material for an energy storage device as defined in claim 3, the method comprising the steps of:
mixing the electrode material for an energy storage device with solution to which polysulfide is added;
irradiating the solution with light after the mixing to determine the absorbance; and
determining whether the electrode material for an energy storage device is bound to polysulfide or not according to a change in absorbance.

16. The method for analyzing the electrode material for an energy storage device according to claim 15, wherein the light is one generated from a UV-visible beam light source.

17. The method for analyzing the electrode material for an energy storage device according to claim 16, wherein the electrode material for an energy storage device is judged to be bound to polysulfide, when the absorbance is decreased.
